(19) United States
(12) Patent Application Publication
(10) Pub. No.: US 2013/0077740 A1
(43) Pub. Date: Mar. 28, 2013

(54) ARRANGEMENT AND METHOD FOR CONTACTLESS SIGNAL TRANSMISSION IN COMPUTED TOMOGRAPHY SYSTEMS

(71) Applicants: Thomas Luthardt, Bamberg (DE); Helmut Repp, Erlangen (DE)

(72) Inventors: Thomas Luthardt, Bamberg (DE); Helmut Repp, Erlangen (DE)

(21) Appl. No.: 13/426,567

(22) Filed: Mar. 21, 2012

(30) Foreign Application Priority Data
Mar. 22, 2011 (DE) 10 2011 005 910.5

(51) Int. Cl. H05G 1/08

(52) U.S. Cl. CPC H05G 1/08
USPC 378/15

(57) ABSTRACT

An arrangement for contactless transmission of electrical signals from at least two signal sources between a fixed gantry section and a gantry section rotatable about an axis of rotation of a computed tomography system is provided. The arrangement includes at least one annular electrical conductor arranged on the rotatable gantry section for emitting the electrical signals. The at least one annular electrical conductor is divided into n annular conductor segments that have no electrical connection to one another. The at least one annular electrical conductor also includes n transmission units. Each of the transmission units is electrically connected to a different annular conductor segment and feeds a different electrical signal into the annular conductor segments. At least two transmission units are electrically connected to different signal sources of the at least two signal sources.

This application claims the benefit of DE 10 2011 005 910.5, filed on Mar. 22, 2011.

### BACKGROUND

The present embodiments relate to an arrangement and a method for contactless transmission of electrical signals between a fixed gantry section and a rotatable gantry section of a computed tomography system.

The area of application of the present embodiments relates to data transmission between a rotating part and a stationary part of a dual-source computed tomography system. During operation of the computed tomography system, data captured by X-ray detectors is to be transmitted from the rotating part to the stationary part of the computed tomography system for further processing at the stationary part. Large volumes of data are to be transmitted in a short time.

Many currently available computed tomography systems use a contactless “slip ring” system for data transmission (e.g., as is known from U.S. Pat. No. 5,140,696 A). This data transmission system includes a transmission unit on the rotating part and a receiving unit on the stationary part. The transmission unit has at least one high-frequency line connected to a transmitter as a transmission antenna. The at least one high-frequency line is arranged on the circumference of the rotating part of a rotating frame. The receiving unit includes a receiver and at least one receiving antenna connected to the receiver. The receiving antenna is formed by a short section of a high-frequency line. During operation of the computed tomography system, the transmission antenna moves in close proximity past the receiving antenna fixed to the stationary part, so that the signals propagating on the transmitting high-frequency line are coupled into the receiving antenna via the near field.

In dual-source computed tomography systems, image data is transmitted by two X-ray detectors. This is effected by two contactless slip ring systems. A disadvantage of this is that the necessary installation space has to be increased in order to accommodate two slip ring systems. The support rings required for this are made larger, which increases the cost and the space requirement.

### SUMMARY AND DESCRIPTION

The present embodiments may obviate one or more of the drawbacks or limitations in the related art. For example, an improved arrangement and an improved method for contactless transmission of electrical signals between two gantry sections of a computed tomography system rotatable relative to one another is provided.

In one embodiment, an arrangement is provided for contactless transmission of electrical signals from at least two signal sources between a fixed gantry section and a gantry section of a computed tomography system rotatable about an axis of rotation. The arrangement includes at least one annular electrical conductor arranged on the rotatable gantry section for emitting the electrical signals. The at least one annular electrical conductor is divided into n, (e.g., with nεN and n>1) annular conductor segments that have no electrical connection to one another. The arrangement includes n transmission units. Each of the transmission units is electrically connected to a different annular conductor segment and feeds different electrical signals into the annular conductor segments. At least two of the transmission units are electrically connected to different signal sources. The annular conductor segments may, for example, be arranged rotationally symmetrically. The present embodiments offer the advantage that data may be transmitted contactlessly from different signal sources with a single annular transmission path, thereby saving space and costs.

In one embodiment, the signal sources are embodied as X-ray detectors. As a result, image data may be transmitted from several detectors in a space-saving and cost-saving manner.

In another embodiment, the annular conductor segments may include emitter elements that emit the electrical signals in the form of electromagnetic waves.

The emitter elements may be embodied as strip lines, which are easy to manufacture.

In one embodiment, the axis of rotation may be the system axis of the computed tomography system.

In another embodiment, a center point of the annular conductor may lie on the axis of rotation of the rotatable gantry section.

The arrangement may include n+1 receiving units that contactlessly couple out the electrical signals fed into the annular conductor segments from the annular conductor segments.

In one embodiment, each receiving unit may include an antenna, using which the electrical signals may be coupled out.

In another embodiment, the receiving units may be annularly arranged on the fixed gantry section.

In one embodiment, n>2 and, at least one signal source is electrically connected to two transmission units.

A computed tomography system with a gantry having two gantry sections and one embodiment of an arrangement is provided.

A method for contactless transmission of electrical signals from at least two signal sources of a computed tomography system between annular conductor segments rotatable about an axis of rotation and fixed receiving units is provided. The electrical signals from different signal sources are transmitted from different annular conductor segments to the receiving units.

In one embodiment of the method, the electrical signals may be emitted by transmission units that are each electrically connected to an annular conductor segment.

In another embodiment, the electrical signals may be transmitted electromagnetically.

### BRIEF DESCRIPTION OF THE DRAWINGS

FIG. 1 shows one embodiment of a computed tomography system;

FIG. 2 shows a block diagram of one embodiment of an arrangement for contactless signal transmission with two annular conductor segments; and

FIG. 3 shows a block diagram of one embodiment of an arrangement for contactless signal transmission with three annular conductor segments.

### DETAILED DESCRIPTION OF THE DRAWINGS

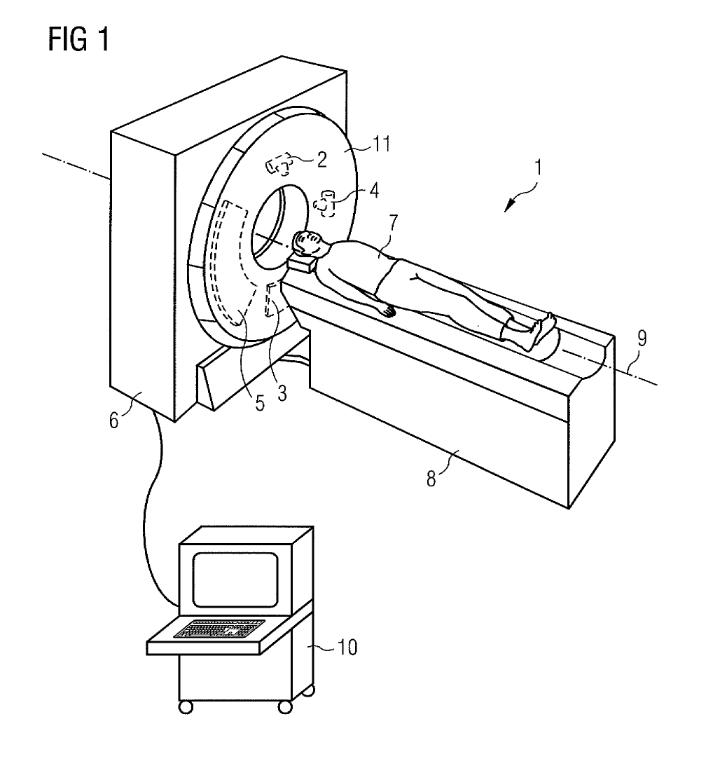

FIG. 1 shows one embodiment of a dual-source computed tomography (CT) system 1 with a fixed gantry section 6. A rotatable gantry section 11 is located in the fixed gantry section 6, and two X-ray tube systems/detector systems are arranged on the rotatable gantry section 11. The two X-ray tube systems/detector systems include an X-ray tube 2 and a detector 3 or an X-ray tube 4 and an opposing detector 5. For an examination, a patient 7 is drawn into a measurement field with the aid of a patient couch 8 that may be moved along a system axis 9, so that absorption of X-ray radiation may be measured from different projection angles. A computer 10 that is designed as a control and arithmetic unit is used to control the CT system 1. Computer programs that implement control of the CT system 1, an analysis of measured data, and a reconstruction of desired tomographic image data run on the computer 10.

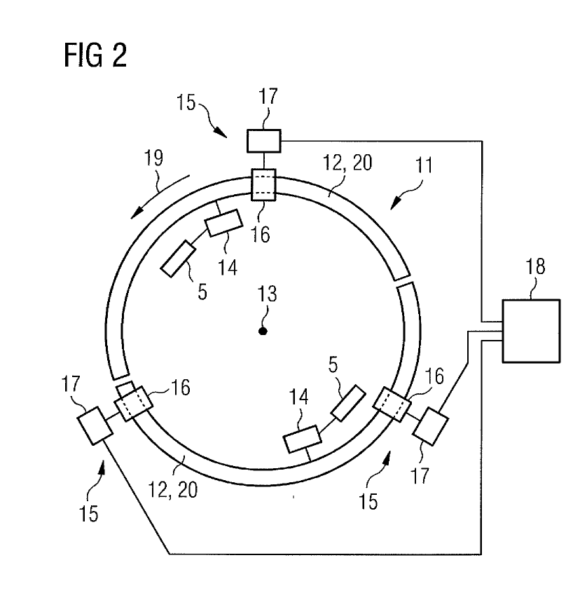

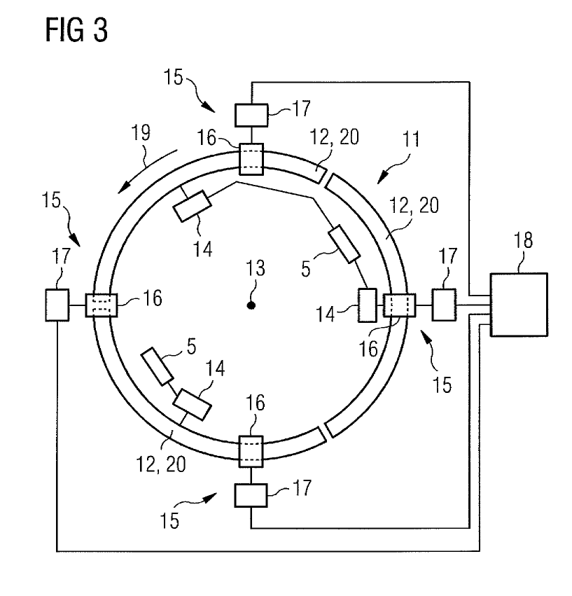

For example, during the transmission of the detector data from the two detectors on the rotatable gantry section 11, a large volume of accrued data is to be transmitted contactlessly. One embodiment of an arrangement for contactless transmission of electrical signals is attached to the rotatable gantry section 11, so that the electrical signals may be transmitted between the fixed gantry gantry section 6 and the rotatable gantry section 11 (e.g., the two gantry sections), which may be rotated relative to one another. Exemplary embodiments of the arrangement of the present embodiments are described in greater detail with reference to FIGS. 2 and 3.

FIG. 2 shows a block diagram of one embodiment of an arrangement for contactless signal transmission with two annular conductor segments 12. The two annular conductor segments 12 may be arranged on a gantry section of a computed tomography system rotatable about an axis of rotation 13 in a direction of rotation 19. The two annular conductor segments 12 are connected to a support ring. A signal source 5 (e.g., an X-ray detector) is, in each case, electrically connected to a transmission unit 14 that feeds electrical signals from the signal source 5 into the annular conductor segment 12 via an electrical connection. The electrical signals are digital data signals provided with a header that provides an unambiguous assignment to a signal source 5 and to a data packet. The two annular conductor segments 12 each include an antenna element 20 (e.g., a strip line) and a line termination (not shown). The antenna elements 20 act as transmission antennas that emit electromagnetic radiation.

With the help of an antenna 16 of each of three receiving units 15, the electrical signals propagating in the two annular conductor segments 12 may be coupled out from the annular conductor segments 12, the electromagnetic radiation from the antenna elements 20 being used. The three receiving units 15 are arranged distributed around the circumference of the two annular conductor segments 12 such that transmission gaps at a transition from one annular conductor segment 12 to the other are avoided. The receiving units 15 each have a receiving circuit 17 that emits the received electrical signals to a data reconstruction unit 18. The data from the signal sources 5 is unambiguously assigned to the two signal sources 5 at the data reconstruction unit 18 on the basis of the header information and is put into the correct sequence. The receiving units 15 and the data reconstruction unit 18 are located, for example, on a fixed gantry section.

Because the data traffic from X-ray detectors is very large, the transmission rate may be approximately 4.25 GBit/s per signal source 5. Data rates of 10 GBit/s and more may be provided. An arrangement according to FIG. 3 may also be used for more data traffic.

FIG. 3 shows a block diagram of one embodiment of an arrangement for contactless signal transmission with three annular conductor segments 12. The annular conductor segments 12 may be arranged on a gantry section of a computed tomography system, rotatable about an axis of rotation 13 in a direction of rotation 19. The annular conductor segments 12 are connected to a support ring. A signal source 5 (e.g., an X-ray detector) is electrically connected to a transmission unit 14 that feeds electrical signals from the signal source 5 into an annular conductor segment 12 via an electrical connection. Another signal source 5 (e.g., another X-ray detector) is electrically connected to two transmission units 14 that feed the different electrical signals from the signal source 5 into two annular conductor segments 12 via an electrical connection. The electrical signals are digital data signals provided with a header that provides an unambiguous assignment to a signal source 5 and to a data packet. The annular conductor segments 12 include an antenna element 20 (e.g., a strip line) and a line termination (not shown).

With the help of an antenna 16 of each of four receiving units 15, the electrical signals propagating in the three annular conductor segments 12 may be coupled out from the annular conductor segments 12. The four receiving units 15 are arranged distributed around the circumference of the three annular conductor segments 12 such that transmission gaps at a transition from one annular conductor segment 12 to the next are avoided. The receiving units 15 have a receiving circuit 17 that emits the received electrical signals to a data reconstruction unit 18. The data from the signal sources 5 is unambiguously assigned to the two signal sources 5 at the data reconstruction unit 18 on the basis of the header information and is put in the correct sequence. The receiving units 15 and the data reconstruction unit 18 are located, for example, on a fixed gantry section. Each transmission unit 14, for example, transmits at 4.25 Gbit/s. Twice as much data may be transmitted from one of the two signal sources, as in the arrangement according to FIG. 2.

The present embodiments may be combined with other contactless transmission methods. In this respect, reference is made to the application DE 10 2005 035 207 A1 and the corresponding application U.S. Pat. No. 7,860,126, which is hereby incorporated by reference.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An arrangement for contactless transmission of electrical signals from at least two signal sources between a fixed gantry section and a rotatable gantry section of a computed tomography system, the rotatable gantry section being rotatable about an axis of rotation, the arrangement comprising:
at least one annular electrical conductor arranged on the rotatable gantry section for emitting the electrical signals, the at least one annular electrical conductor being divided into a plurality of annular conductor segments that have no electrical connection to one another; and
a plurality of transmission units, each transmission unit of the plurality of transmission units being electrically connected to a different annular conductor segment of the plurality of annular conductor segments and feeding different of the electrical signals into the plurality of annular conductor segments, at least two transmission units of the plurality of transmission units being electrically connected to different signal sources of the at least two signal sources.

2. The arrangement as claimed in claim 1, wherein the at least two signal sources comprise X-ray detectors.

3. The arrangement as claimed in claim 1, wherein the plurality of annular conductor segments comprise emitter elements that emit the electrical signals in the form of electromagnetic waves.

4. The arrangement as claimed in claim 2, wherein the emitter elements are strip lines.

5. The arrangement as claimed in claim 1, wherein the axis of rotation is a system axis of the computed tomography system.

6. The arrangement as claimed in claim 4, wherein a center point of the at least one annular conductor lies on the axis of rotation of the rotatable gantry section.

7. The arrangement as claimed in claim 1, further comprising a plurality of receiving units that contactlessly couple out the electrical signals fed into the plurality of annular conductor segments from the plurality of annular conductor segments,
wherein the number of receiving units is one more than the number of transmission units.

8. The arrangement as claimed in claim 7, wherein each receiving unit of the plurality of receiving units comprises an antenna, by which the electrical signals are operable to be coupled out.

9. The arrangement as claimed in claim 7, wherein the plurality of receiving units is distributed annularly on the fixed gantry section.

10. The arrangement as claimed in claim 1, wherein the plurality of transmission units comprises at least three transmission units, and
wherein at least one signal source of the at least two signals sources is electrically connected to two transmission units of the at least three transmission units.

11. The arrangement as claimed in claim 2, wherein the axis of rotation is a system axis of the computed tomography system.

12. The arrangement as claimed in claim 2, further comprising a plurality of receiving units that contactlessly couple out the electrical signals fed into the plurality of annular conductor segments from the plurality of annular conductor segments,
wherein the number of receiving units is one more than the number of transmission units.

13. The arrangement as claimed in claim 8, wherein the plurality of receiving units is distributed annularly on the fixed gantry section.

14. The arrangement as claimed in claim 2, wherein the plurality of transmission units comprises at least three transmission units, and
at least one signal source of the at least two signals sources is electrically connected to two transmission units of the at least three transmission units.

15. The arrangement as claimed in claim 3, wherein the plurality of transmission units comprises at least three transmission units, and
wherein at least one signal source of the at least two signals sources is electrically connected to two transmission units of the at least three transmission units.

16. A computed tomography system comprising:
a gantry comprising:
a fixed gantry section;
a rotatable gantry section that is rotatable about an axis of rotation; and
an arrangement for contactless transmission of electrical signals from at least two signal sources between the fixed gantry section and the rotatable gantry section, the arrangement comprising:
at least one annular electrical conductor arranged on the rotatable gantry section for emitting the electrical signals, the at least one annular electrical conductor being divided into a plurality of annular conductor segments that have no electrical connection to one another; and
a plurality of transmission units, each transmission unit of the plurality of transmission units being electrically connected to a different annular conductor segment of the plurality of annular conductor segments and feeding different of the electrical signals into the plurality of annular conductor segments, at least two transmission units of the plurality of transmission units being electrically connected to different signal sources of the at least two signal sources.

17. A method for contactless transmission of electrical signals from at least two signal sources of a computed tomography system, the contactless transmission being between annular conductor segments rotatable about an axis of rotation and fixed receiving units, the method comprising:
transmitting the electrical signals from different signal sources of the at least two signal sources from different of the annular conductor segments to the fixed receiving units.

18. The method as claimed in claim 17, wherein the electrical signals are emitted by transmission units that are electrically connected to the annular conductor segments.

19. The method as claimed in claim 17, wherein the electrical signals are transmitted electromagnetically.

20. The method as claimed in claim 19, wherein the electrical signals are transmitted electromagnetically.
